(19) United States
(12) Patent Application Publication
(10) Pub. No.: US 2015/0033853 A1
(43) Pub. Date: Feb. 5, 2015

(54) MEMS GYROSCOPE

(71) Applicant: INSIGHTECH, LLC, LOS ANGELES, CA (US)

(72) Inventors: Biao Zhang, HINSDALE, IL (US); TAO JU, BEIJING (CN)

(73) Assignee: INSIGHTECH, LLC, LOS ANGELES, CA (US)

(21) Appl. No.: 14/518,317

(22) Filed: Oct. 20, 2014

Related U.S. Application Data
(63) Continuation of application No. 13/559,625, filed on Jul. 27, 2012, now abandoned.
(60) Provisional application No. 61/653,408, filed on May 31, 2012.

(51) Int. Cl. G01C 19/56; G01P 15/105

(52) U.S. Cl. CPC G01C 19/56; G01P 15/105
USPC 73/504.12

(57) ABSTRACT

A MEMS gyroscope is disclosed herein, wherein the MEMS gyroscope comprised plurality of movable portions that are capable of moving in response to angular velocity and a plurality of magnetic sensing mechanisms for measuring movements of the movable portions.

### CROSS-REFERENCE

This US utility patent application claims priority from co-pending US utility patent application “A HYBRID MEMS DEVICE,” Ser. No. 13/559,625 filed Jul. 27, 2012, which claims priority from US provisional patent application “A HYBRID MEMS DEVICE,” tiled May 31, 2012, Ser. No. 61/653,408 to Biao Zhang and Tao Ju. This US utility patent application also claims priority from co-pending US utility patent application “A MEMS DEVICE,” Ser. No. 13/854,972 filed Apr. 2, 2013 to the same inventor of this US utility patent application, the subject matter of each of which is incorporated herein by reference in its entirety.

### TECHNICAL FIELD OF THE DISCLOSURE

The technical field of the examples to be disclosed in the following sections is related generally to the art of operation of microstructures, and, more particularly, to operation of MEMS devices comprising MEMS magnetic sensing structures.

### BACKGROUND OF THE DISCLOSURE

Microstructures, such as microelectromechanical (hereafter MEMS) devices (e.g. accelerometers, DC relay and RF switches, optical cross connects and optical switches, microlenses, reflectors and beam splitters, filters, oscillators and antenna system components, variable capacitors and inductors, switched banks of filters, resonant comb-drives and resonant beams, and micromirror arrays for direct view and projection displays) have many applications in basic signal transduction. For example, a MEMS gyroscope measures angular rate.

A gyroscope (hereafter “gyro” or “gyroscope”) is based on the Coriolis effect as diagrammatically illustrated in FIG. it. Proof-mass 100 is moving with velocity V_{d}. Under external angular velocity Ω, the Coriolis effect causes movement of the poof-mass (100) with velocity Vₛ. With fixed V_{d}, the external angular velocity can be measured from V_{d}. A typical example based on the theory shown in FIG. 1 is capacitive MEMS gyroscope, as diagrammatically illustrated in FIG. 2.

The MEMS gyro is a typical capacitive MEMS gyro, which has been widely studied. Regardless of various structural variations, the capacitive MEMS gyro in FIG. 2 includes the very basic theory based on which all other variations are built. In this typical structure, capacitive MEMS gyro 102 is comprised of proof-mass 100, driving mode 104, and sensing mode 102. The driving mode (104) causes the proof-mass (100) to move in a predefined direction, and such movement is often in a form of resonance vibration. Under external angular rotation, the proof-mass (100) also moves along the Vₛ direction with velocity Vₛ. Such movement of Vₛ is detected by the capacitor structure of the sensing mode (102). Both of the driving and sensing modes use capacitive structures, whereas the capacitive structure of the driving mode changes the overlaps of the capacitors, and the capacitive structure of the sensing mode changes the gaps of the capacitors.

Current capacitive MEMS gyros, however, are hard to achieve submicro-g/rtHz because the capacitance between sensing electrodes decreases with the miniaturization of the movable structure of the sensing element and the impact of the stray and parasitic capacitance increase at the same time, even with large and high aspect ratio proof-masses.

Therefore, what is desired is a MEMS device capable of sensing angular velocities and methods of operating the same.

### SUMMARY OF THE DISCLOSURE

In view of the foregoing, a MEMS gyroscope is disclosed herein, wherein the gyroscope comprises: a first substrate, comprising: a plurality of movable portions, each of which is movable in response to an external angular velocity, wherein at least a pair of proof-masses move in opposite directions in response to said angular velocity; a plurality of magnetic sources for said movable portions for generating magnetic fields; and a second substrate having a plurality of magnetic sensors for detecting the magnetic fields from said magnetic sources.

### BRIEF DESCRIPTION OF DRAWINGS

FIG. 1 diagrammatically illustrates the Coriolis effect in a MEMS structure;

FIG. 2 is a top view of a typical existing capacitive MEMS gyroscope having a driving mode and a sensing mode, wherein both of the driving and sensing mode utilize capacitance structures;

FIG. 3 illustrates an exemplary MEMS gyroscope having a magnetic sensing mechanism;

FIG. 4 illustrates a top view of a portion of an exemplary implementation of the MEMS gyroscope illustrated in FIG. 3, wherein the MEMS gyroscope illustrated in FIG. 4 having a capacitive driving mode and a magnetic sensing mechanism;

FIG. 5 illustrates a perspective view of a portion of another exemplary implementation of the MEMS gyroscope illustrated in FIG. 3, wherein the MEMS gyroscope illustrated in FIG. 5 having a magnetic driving mechanism for the driving mode and a magnetic sensing mechanism for the sensing mode

FIG. 6 illustrates an exemplary magnetic driving mechanism of the MEMS gyroscope in FIG. 5;

FIG. 7 illustrates an exemplary magnetic source of the MEMS gyroscope illustrated in FIG. 3;

FIG. 8 illustrates an exemplary magnetic sensing mechanism that can be used in the MEMS gyroscope illustrated in FIG. 3;

FIG. 9 shows an exemplary thin-film stack that can be configured into a CIP or CPP structure for use in the magnetic sensing mechanism illustrated in FIG. 8;

FIG. 10 illustrates an exemplary MEMS gyroscope that comprises multiple magnetic sensing structures;

FIG. 11 illustrates an exemplary MEMS gyroscope that comprises multiple proof-masses;

FIG. 12 illustrates an exemplary MEMS gyroscope that comprises multiple proof-masses having a magnetic driving mechanism;

FIG. 13a and FIG. 13b illustrate an exemplary driving scheme for use in the MEMS gyroscope illustrated in FIG. 12; and

FIG. 14 illustrates an exemplary magnetic source and magnetic sensing mechanism of the MEMS gyroscope illustrated in FIG. 13.

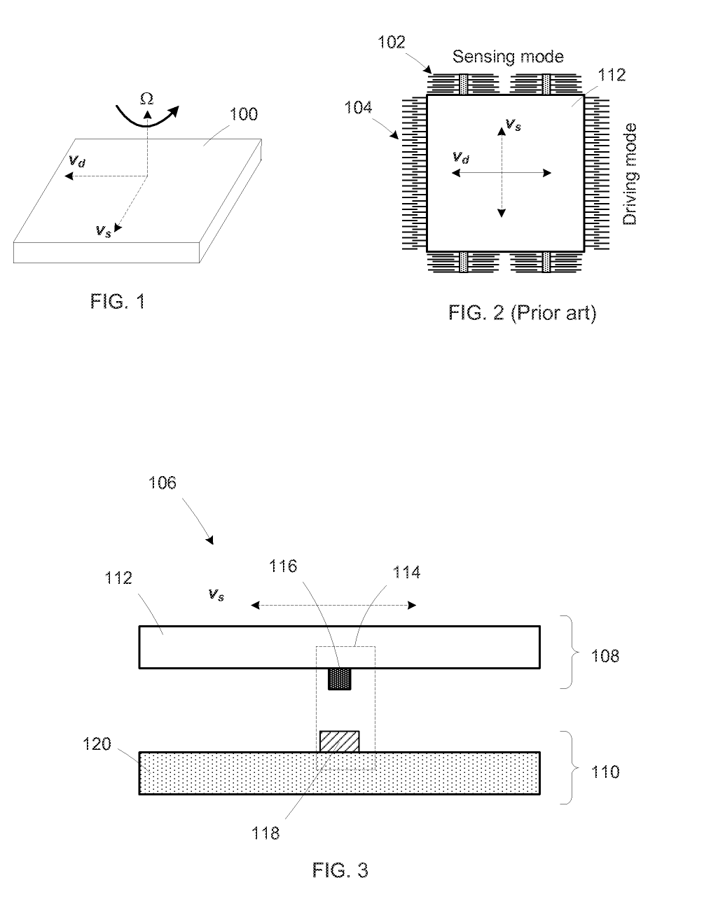

### DETAILED DESCRIPTION OF SELECTED EXAMPLES

Disclosed herein is a MEMS gyroscope for sensing an angular velocity, wherein the MEMS gyroscope utilizes a magnetic sensing mechanism. It will be appreciated by those skilled in the art that the following discussion is for demonstration purposes, and should not be interpreted as a limitation. Many other variations within the scope of the following disclosure are also applicable. For example, the MEMS gyroscope and the method disclosed in the following are applicable for use in accelerometers.

Referring to FIG. 3, an exemplary MEMS gyroscope is illustrated herein. In this example, MEMS gyroscope 106 comprises magnetic sensing mechanism 114 for sensing the target angular velocity through the measurement of proof-mass 112. Specifically, MEMS gyroscope 106 comprises mass-substrate 108 and sensor substrate 110. Mass-substrate 108 comprises proof-mass 112 that is capable of responding to an angular velocity. The two substrates (108 and 110) are spaced apart, for example, by a pillar (not shown herein for simplicity) such that at least the proof-mass (112) is movable in response to an angular velocity under the Coriolis effect. The movement of the proof-mass (112) and thus the target angular velocity can be measured by magnetic sensing mechanism 114.

The magnetic sensing mechanism (114) in this example comprises a magnetic source 116 and magnetic sensor 118. The magnetic source (116) generates a magnetic field, and the magnetic sensor (118) detects the magnetic field and/or the magnetic field variations that is generated by the magnetic source (116). In the example illustrated herein in FIG. 3, the magnetic source is placed on/in the proof-mass (112) and moves with the proof-mass (112). The magnetic sensor (118) is placed on/in the sensor substrate (120) and non-movable relative to the moving proof-mass (112) and the magnetic source (116). With this configuration, the movement of the proof-mass (112) can be measured from the measurement of the magnetic field from the magnetic source (116).

Other than placing the magnetic source on/in the movable proof-mass (1112), the magnetic source (116) can be placed on/in the sensor substrate (120); and the magnetic sensor (118) can be placed on/in the proof-mass (112).

It is also noted that the MEMS gyroscope illustrated in FIG. 3 can also be used as an accelerometer.

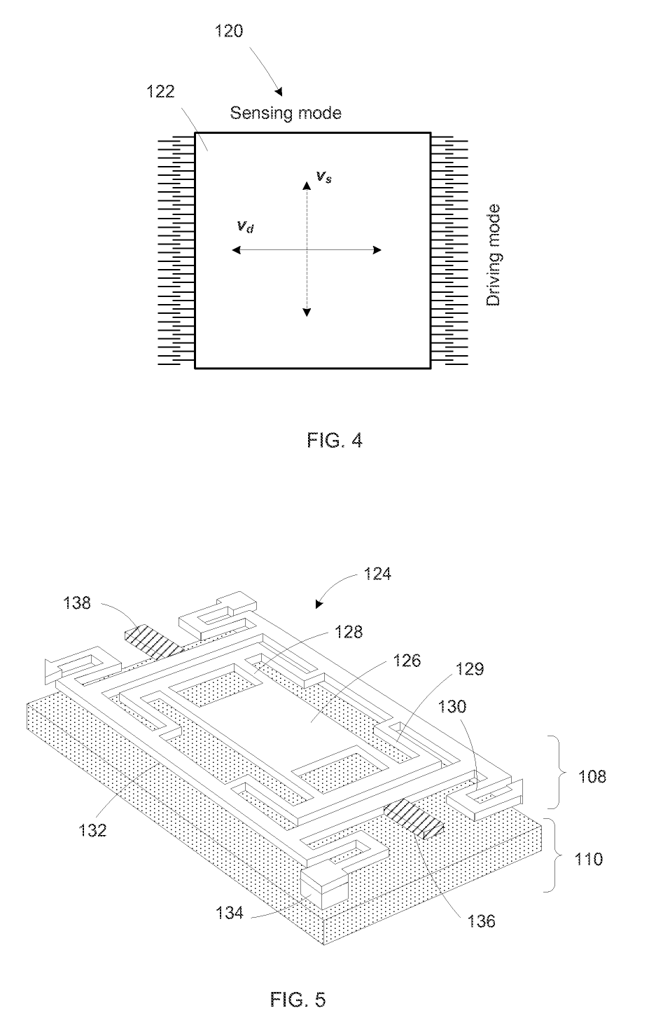

The MEMS gyroscope as discussed above with reference to FIG. 3 can be implemented in many ways, one of which is illustrated in FIG. 4. Referring to FIG. 4, the proof-mass (120) is driven by capacitive, such as capacitive comb. The sensing mode, however, is performed using the magnetic sensing mechanism illustrated in FIG. 3. For this reason, capacitive combs can be absent from the proof-mass (120).

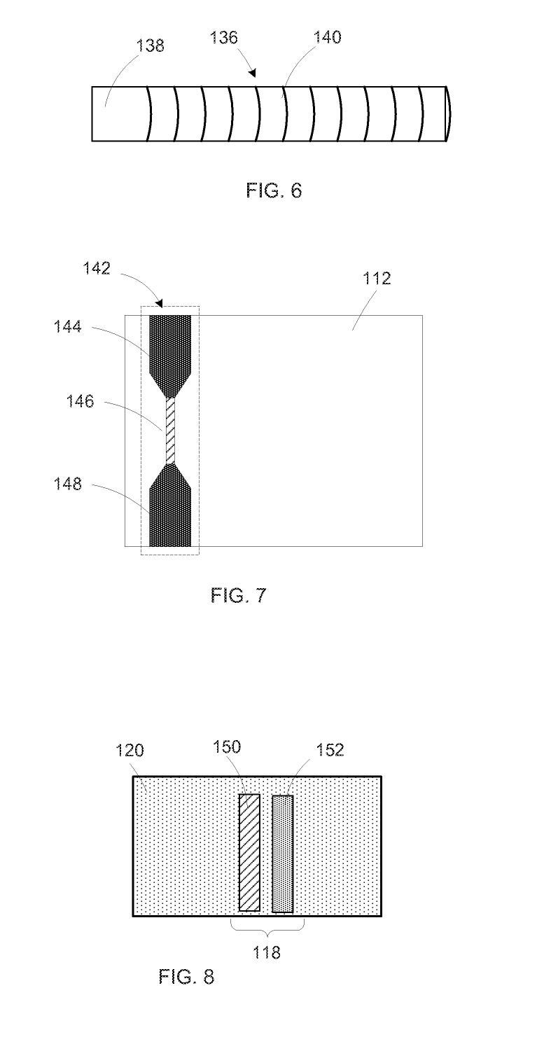

Alternatively, the proof-mass can be driven by magnetic force, an example of which is illustrated in FIG. 5. Referring to FIG. 5, the mass substrate (108) comprises a movable proof-mass (126) that is supported by flexible structures such as flexures 128, 129, and 130. The layout of the flexures enables the proof-mass to move in a plane substantially parallel to the major planes of mass substrate 108. In particular, the flexures enables the proof-mass to move along the length and the width directions, wherein the length direction can be the driving mode direction and the width direction can be the sensing mode direction of the MEMS gyro device. The proof-mass (126) is connected to frame 132 through flexures (128, 129, and 130). The frame (132) is anchored by non-movable structures such as pillar 134. The mass-substrate (108) and sensing substrate 110 are spaced apart by the pillar (134). The proof-mass (112) in this example is driving by a magnetic driving mechanism (136). Specifically, the proof-mass (126) can move (e.g. vibrate) in the driving mode under magnetic force applied by magnetic driving mechanism 136, which is better illustrated in FIG. 6.

Referring to FIG. 6, the magnetic driving mechanism 136 comprise a magnet core 138 surrounded by coil 140. By applying an alternating current through coil 140, an alternating magnetic field can be generated from the coil 140. The alternating magnetic field applies magnetic force to the magnet core 140 so as to move the magnet core. The magnet core thus moves the proof-mass.

The magnetic source (114) of the MEMS gyroscope (106) illustrated in FIG. 3 can be implemented in many ways, one of which is illustrated in FIG. 7. Referring to FIG. 7, conductive wire 142 is displaced on/in proof-mass 112. In one example, conductive wire 142 can be placed on the lower surface of the proof-mass (112), wherein the lower surface is facing the magnetic sensors (118 in FIG. 3) on the sensor substrate (110, in FIG. 3). Alternatively, the conductive wire (142) can be placed on the top surface of the proof-mass (112), i.e. on the opposite side of the proof-mass (112) in view of the magnetic sensor (118). In another example, the conductive wire (142) can be placed inside the proof-mass, e.g. laminated or embedded inside the proof-mass (112), which will not be detailed herein as those examples are obvious to those skilled in the art of the related technical field.

The conductive wire (142) can be implemented in many suitable ways, one of which is illustrated in FIG. 7. In this example, the conductive wire (142) comprises a center conductive segment 146 and tapered contacts 144 and 148 that extend the central conductive segment to terminals, through the terminals of which current can be driven through the central segment. The conductive wire (142) may have other configurations. For example, the contact tapered contacts (144 and 148) and the central segment (146) maybe U-shaped such that the tapered contacts may be substantially parallel but are substantially perpendicular to the central segment, which is not shown for its obviousness.

The magnetic sensor (118) illustrated in FIG. 3 can be implemented to comprise a reference sensor (150) and a signal sensor (152) as illustrated in FIG. 8. Referring to FIG. 8, magnetic senor 118 on/in sensor substrate 120 comprises reference sensor 150 and signal sensor 152. The reference sensor (150) can be designated for dynamically measuring the magnetic signal background in which the target magnetic signal (e.g. the magnetic field from the conductive wire 146 as illustrated in FIG. 7) co-exists. The signal sensor (152) can be designated for dynamically measuring the target magnetic signal (e.g. the magnetic field from the conductive wire 146 as illustrated in FIG. 7). In other examples, the signal sensor (152) can be designated for dynamically measuring the magnetic signal background in which the target magnetic signal (e.g. the magnetic field from the conductive wire 146 as illustrated in FIG. 7) co-exists, while the signal sensor (150) can be designated for dynamically measuring the target magnetic signal (e.g. the magnetic field from the conductive wire 146 as illustrated in FIG. 7).

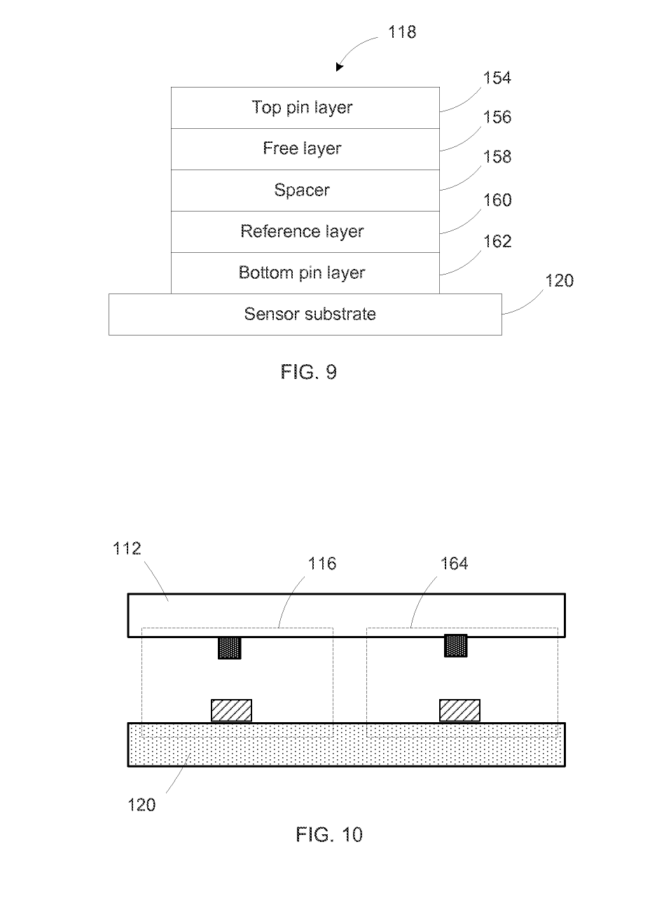

The reference sensor (150) and the signal sensor (152) preferably comprise magneto-resistors, such as AMRs, giant-magneto-resistors (such as spin-valves, hereafter SV), or tunneling-magneto-resistors (TMR). For demonstration purpose, FIG. 9 illustrates a magneto-resistor structure, which can be configured into CIP (current-in-plane, such as a spin-valve) or a CPP (current-perpendicular-to-plane, such as TMR structure). As illustrated in FIG. 9, the magneto-resistor stack comprises top pin-layer 154, free-layer 156, spacer 158, reference layer 160, bottom pin layer 162, and substrate 120. Top pin layer 154 is provided for magnetically pinning free layer 156. The top pin layer can be comprised of IrMn, PtMn or other suitable magnetic materials. The free layer (156) can be comprised of a ferromagnetic material, such as NiFe, CoFe, CoFeB, or other suitable materials or the combinations thereof. The spacer (158) can be comprised of a non-magnetic conductive material, such as Cu, or an oxide material, such as Al₂O₃ or MgO or other suitable materials. The reference layer (160) can be comprised of a ferromagnetic magnetic material, such as NiFe, CoFe, CoFeB, or other materials or the combinations thereof. The bottom pin layer (162) is provided for magnetic pinning the reference layer (160), which can be comprised of a IrMn, PtMn or other suitable materials or the combinations thereof. The substrate (120) can be comprised of any suitable materials, such as glass, silicon, or other materials or the combinations thereof.

In examples wherein the spacer (158) is comprised of a non-magnetic conductive layer, such as Cu, the magneto-resistor (118) stack can be configured into a CIP structure (i.e. spin-valve, SV), wherein the current is driven in the plane of the stack layers. When the spacer (158) is comprised of an oxide such as Al₂O₃, MgO or the like, the magneto-resistor stack (118) can be configured into a CPP structure (i.e. TMR), wherein the current is driven perpendicularly to the stack layers.

In the example as illustrated in FIG. 9, the free layer (156) is magnetically pinned by the top pin layer (154), and the reference layer (160) is also magnetically pinned by bottom pin layer 162. The top pin layer (154) and the bottom pin layer (162) preferably having different blocking temperatures. In this specification, a blocking temperature is referred to as the temperature, above which the magnetic pin layer is magnetically decoupled with the associated pinned magnetic layer. For example, the top pin layer (154) is magnetically decoupled with the free layer (156) above the blocking temperature T_{B} of the top pin layer (154) such that the free layer (156) is “freed” from the magnetic pinning of top pin layer (154). Equal to or below the blocking temperature T_{B} of the top pin layer (154), the free layer (156) is magnetically pinned by the top pin layer (154) such that the magnetic orientation of the free layer (156) is substantially not affected by the external magnetic field. Similarly, the bottom pin layer (162) is magnetically decoupled with the reference layer (160) above the blocking temperature T_{B} of the bottom pin layer (162) such that the reference layer (160) is “freed” from the magnetic pinning of bottom pin layer (162). Equal to or below the blocking temperature T_{B} of the bottom pin layer (162), the reference layer (160) is magnetically pinned by the bottom pin layer (162) such that the magnetic orientation of the reference layer (162) is substantially not affected by the external magnetic field.

The top and bottom pin layers (154 and 162, respectively) preferably have different blocking temperatures. When the free layer (156) is “freed” from being pinned by the top pin layer (154), the reference layer (160) preferably remains being pinned by the bottom pin layer (162). Alternatively, when the free layer (156) is still pinned by the top pin layer (154), the reference layer (160) can be “freed” from being pinned by the bottom pin layer (162). In the later example, the reference layer (160) can be used as a “sensing layer” for responding to the external magnetic field such as the target magnetic field, while the free layer (156) is used as a reference layer to provide a reference magnetic orientation.

The different blocking temperatures can be accomplished by using different magnetic materials for the top pin layer (154) and bottom pin layer (162). In one example, the top pin layer (154) can be comprised of IrMn, while the bottom pin layer (162) can be comprised of PtMn, vice versa. In another example, both of the top and bottom pin layers (154 and 162) may be comprised of the same material, such as IrMn or PtMn, but with different thicknesses such that they have different blocking temperatures.

It is noted by those skilled in the art that the magneto-resistor stack (118) is configured into sensors for sensing magnetic signals. As such, the magnetic orientations of the free layer (156) and the reference layer (160) are substantially perpendicular at the initial state. Other layers, such as protective layer Ta, seed layers for growing the stack layers on substrate 120 can be provided. It is further noted that the magnetic stack layers (118) illustrated in FIG. 9 are what is often referred to as “bottom pin” configuration in the field of art. In other examples, the stack can be configured into what is often referred as “top pinned” configuration in the field of art, which will not be detailed herein.

In some applications, multiple magnetic sensing mechanisms can be provided, an example of which is illustrated in FIG. 10. Referring to FIG. 10, magnetic sensing mechanisms 116 and 164 are provided for detecting the movements of proof-mass 112. The multiple magnetic sensing mechanisms can be used for detecting the movements of proof-mass 112 in driving mode and sensing mode respectively. Alternatively, the multiple magnetic sensing mechanisms 116 and 16.4 can be provided for detecting the same modes (e.g. the driving mode and/or the sensing mode).

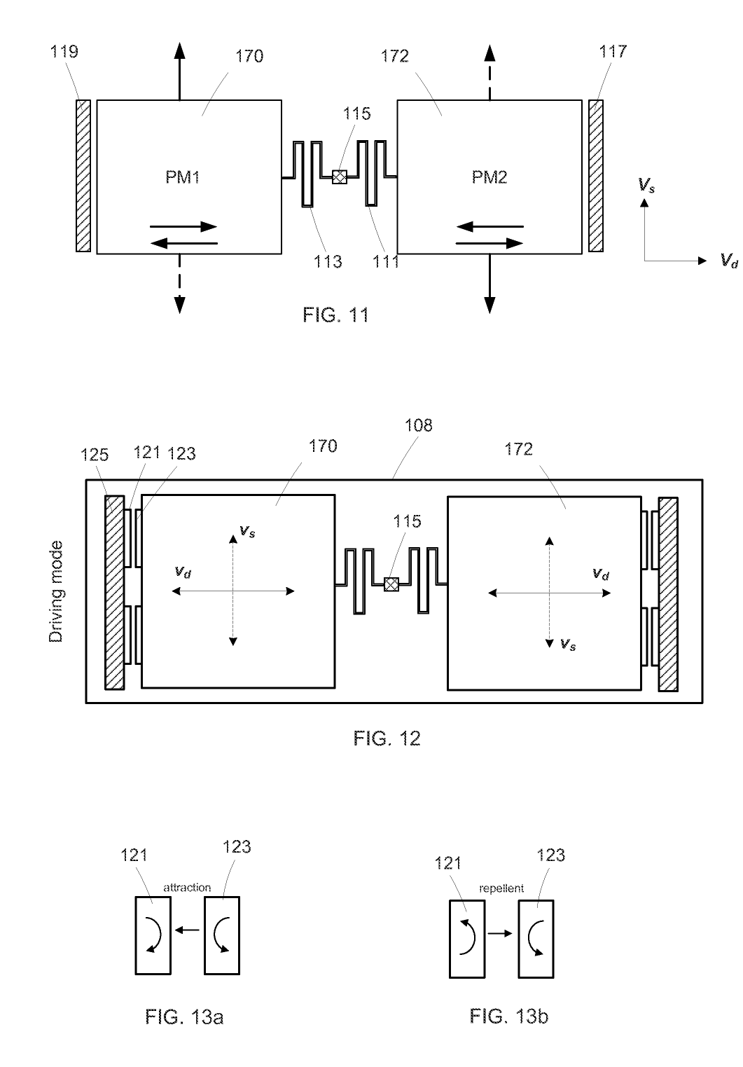

In operation, angular velocity Z direction (perpendicular to the driving and sensing direction) causes the motion of the proof-mass in the sensing direction. However, acceleration in the sensing direction also causes the motion of the proof-mass in the sensing direction. As a consequence, motion of the proof-mass in the sensing direction is a mixture of both of the angular velocity in the Z direction and acceleration in the sensing direction when both exist. The signal measured by the magnetic sensing mechanism is thus a mixture of the signals associated with the proof-mass motion in both directions. A solution to separate signals from the angular velocity in Z direction and acceleration in the sensing direction can be provision of multiple proof-masses, an example of which is illustrated in FIG. 11. It is noted that the example illustrated in FIG. 11 having two proof-masses is only for demonstration purposes. Other variations within the scope of this disclosure are also applicable. For example, more than two proof-masses, such as four or eight proof-masses can be provided in a MEMS gyroscope.

Referring to FIG. 11, proof-masses PM1 170 and PM2 172 are provided in a MEMS gyroscope. The proof-masses (170 and 172) are connected to anchor 115 through flexures 111 and 113 such that the proof-masses are capable of moving in the driving and sensing directions. It is noted that the proof-masses (170 and 172) are associated with other mechanical structures to enable the motion of the proof-masses, and those mechanical structures are not shown herein for simplicity. Driving mechanisms 117 and 119 are provided for driving the proof-masses (170 and 172) in their driving modes. The driving mechanisms may comprise capacitors or magnetic driving mechanisms or other suitable structures.

To separate the angular velocity in the Z direction and acceleration in the sensing direction, the proof-masses PM1 and PM2 move in opposite directions along the driving directions. For example, the proof-masses PM1 and PM2 move at the same time toward anchor 115 or at the same time, away from anchor 115. Because the proof-masses PM1 and PM2 have opposite velocities in the driving direction, they also move in opposite directions in the sensing direction under the Coriolis force due to angular velocity in the Z direction. In existence of accelerate in the sensing direction, both of the proof-masses 170 and 172 move in the same direction at the same time. By analyzing the moving directions of the proof-masses 170 and 172, signals caused by the angular velocity in the Z direction and acceleration in the sensing direction can be separated.

As an example, FIG. 12 illustrates the MEMS substrate of a MEMS gyroscope having multiple proof-masses and using magnetic driving mechanism. Referring to FIG. 12, proof-masses 170 and 172 are formed in MEMS substrate 108. The proof-masses 170 and 172 are connected to and held by anchor 115 through flexures. The proof-masses 170 and 172 each are connected to a magnetic driving mechanism. For example, proof-mass 170 is connected to movable coil 123 that moves with proof-mass 170. Movable coil 123 is coupled to static coil 121 that is affixed to anchor 125 such that static coil 121 does not move relative to substrate 108 when proof-masses 170 and 172 are moving.

By driving current in the coupled coils in selected directions, the coils generate attractive and repel forces, as illustrated in FIG. 13a and FIG. 13b. Referring to FIG. 13a, the direction of the current through movable coil 123 can be fixed, for example counter-clockwise. When the current in static coil 121 has a clockwise direction, the coils 121 and 123 generate attractive force. Because the static coil (121) is affixed to anchor 125 and static, the movable coil (123) is moves towards the static coil (121) under the attractive force, and so does the proof-mass (170). When both of the current in the static coil (121) and movable coil (123) have counter-clockwise direction, as illustrated in FIG. 13bc, the force between the two coils is repellent. The movable coil (123), so does the proof-mass (170), moves away from the static coil (121) under the repellent force.

By changing the direction of the current in the static coil white keeping the current direction in the movable coil unchanged, the proof-mass (170) can be moved towards and away from the static coil (121). In other examples, the current direction of the static coil (121) can be unchanged during operation, while the direction of the current in the movable coil (123) is varied. In another example, both of the directions of the current in the static and movable loops can be varied during operation to driving the movable loop, as well as the proof-mass, away and towards the anchor (125). In any examples, the frequency of changing the current direction can be equal or close to the resonate frequency of the proof-mass in the driving direction. It is noted that multiple static and movable loop pairs can be provided for a proof-mass to increase the driving efficiency, even though FIG. 4a shows two coil pairs.

Proof-mass 172 can be driving in the same way as proof-mass 170 by using the magnetic driving mechanism associated therewith. In order to separate signal of the Z direction angular velocity from the acceleration in the sensing direction, proof-masses 170 and 172 are driving in opposite directions in the sensing mode as discussed above with reference to FIG. 11, which will not be repeated herein.

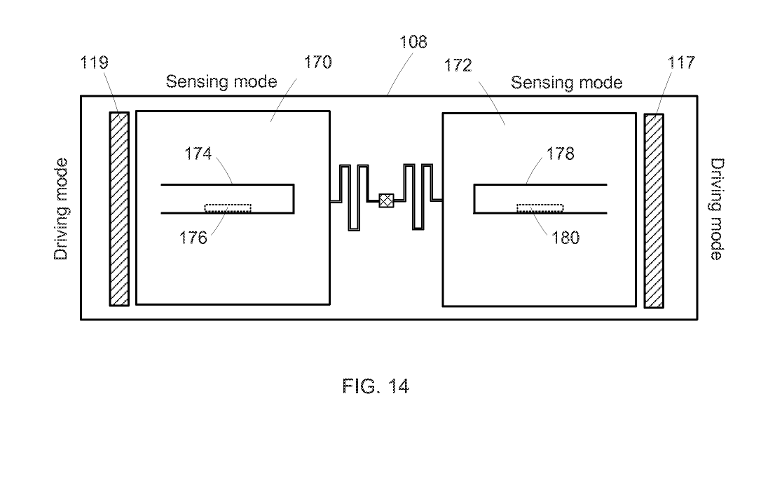

For detecting the motion of the proof-masses (170 and 172), multiple magnetic sensing mechanisms are provided, and example of which is illustrated in FIG. 14. Referring to FIG. 14, Proof-mass 170 is provided with a conducting wire (174) as a magnetic field source for generating magnetic field. The conducting wire (174) can be formed at the bottom surface of proof-mass 170 as discussed above with reference to FIG. 3. Associated with conducting wire 170 is magnetic sensor 176 for measuring the magnetic field from conducting wire 174. The magnetic sensor (176) is formed on sensor substrate 110 as shown in FIG. 3. The magnetic sensor 176 can be the same as magnetic sensor 118 as discussed above with reference to FIG. 3. It is noted that magnetic sensor 176, when comprised of a solid-state spintronic structure, such as a spin-valve or magnetic-tunnel-junction, can be offset from conducting wire 174 along the direction of the sensing mode. Specifically, the geometric center of magnetic sensor 176 is offset from the closest conducting wire passing by. Similar to that for proof-mass 170, proof-mass 172 is provided with conducting wire 178 and associated sensing mechanism 180, which will not be repeated herein.

It will be appreciated by those of skilled in the art that a new and useful MEMS gyroscope has been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof. In the claims, only elements denoted by the words “means for” are intended to be interpreted as means plus function claims under 35 U.S.C. §112, the sixth paragraph.

We claim:

1. A MEMS gyroscope, comprising:
a first substrate, comprising:
a plurality of movable portions, each of which is movable in response to an external angular velocity, wherein at least a pair of proof-masses move in opposite directions in response to said angular velocity;
a plurality of magnetic sources for said movable portions for generating magnetic fields; and
a second substrate having a plurality of magnetic sensors fir detecting the magnetic fields from said magnetic sources.

2. The MEMS gyroscope of claim 1, wherein the magnetic source comprises a conducting wire.

3. The MEMS gyroscope of claim 1, wherein the magnetic source comprises a magnetic nanoparticle.

4. The MEMS gyroscope of claim 2, wherein the magnetic sensor comprises a giant-magnetic-resistor.

5. The MEMS gyroscope of claim 2, wherein the magnetic sensors comprises a spin-valve structure.

6. The MEMS gyroscope of claim 2, wherein the magnetic sensors comprises a tunnel-magnetic-resistor.

7. The MEMS gyroscope of claim 2, wherein the magnetic sensors comprises a magnetic pickup coil that is an element of a fluxgate.
